(19) United States
(12) Patent Application Publication
(10) Pub. No.: US 2009/0220708 A1
(43) Pub. Date: Sep. 3, 2009

(54) SYSTEM FOR LENTICULAR PRINTING

(76) Inventor: Peter SCHMITT, Wuerzburg (DE)

Correspondence Address: K.F. ROSS P.C., 5683 RIVERDALE AVENUE, SUITE 203 BOX 900, BRONX, NY, 10471-0900, US

(21) Appl. No.: 12/393,404

(22) Filed: Feb. 26, 2009

(30) Foreign Application Priority Data
Feb. 28, 2008 (DE) 102008011556.8

(51) Int. Cl. B44F 1/00; G02B 3/00; B31F 1/07

(52) U.S. Cl. 428/29; 264/1.32; 101/32

(57) ABSTRACT

A method of making a printed product having an optical effect based on light refraction has the steps of applying an embossable coating to face of a substrate in an image zone, embossing an optical structure in the embossable coating, curing the embossed coating, and printing an image on the substrate in the image zone.

### FIELD OF THE INVENTION

The present invention relates to a system for lenticular printing and a product produced thereby. More particularly this invention concerns a method of and apparatus of making a printed product having an optical effect based on light refraction, in particular a lenticular image.

### BACKGROUND OF THE INVENTION

Lenticular printing to produce different optical effects with a printed product, such as for example 3D effects or flip images or wiggle images has been known from many years and is being offered to an increased extent in particular of late, since the necessary print quality can now be achieved on a number of different printing machines.

To this end, for example, an unprinted transparent lenticular screen film is provided on the face opposite the lenticular screen with a printed image corresponding to the lenticular screen and comprising several individual images, so that when the printed image is viewed through the lenticular screen an optical effect, for example a three-dimensional impression of the image, is produced or, when the image is viewed from different viewing angles, different images are visible.

The lenticular screen films are thereby essentially structured such that they form an array of identical cylindrical lenses lying next to one another, the number of lenses per inch (LPI) being different depending on the embodiment of the lenticular screen film and, for example can lie between 10 LPI and 150 LPI. Usual values thereby lie between 40 LPI and 100 LPI. The focal points of the lenses lie on the face of the lenticular screen film opposite the lenses, thus in particular on the smooth face of the film without the lenticular screen.

The printing of known films of this type is carried out in that a strip-shaped partial image of a desired printed image is printed behind each of the lenses on the face of the lenticular screen film opposite the lenses, each partial image strip being assembled from at least two different strips of different starting images. When the printed image is viewed through the lens face, due to the position of the printed images in the focal plane of the lenses depending on the viewing angle, a viewer therefore always sees only one partial zone of a respective partial image strip behind each lens, all visible partial image strips being combined to form one total image.

If the viewing angle is changed, then the visible portions of the partial image strips are also changed so that, for example, a different total image is visible or, with a spatial representation of an object, it can be seen from a different viewing angle.

The lenticular screen films necessary for this, at least within one production batch, may have only the slightest deviations from predetermined desired measurements and a predetermined desired shape, since otherwise printing of the lenticular screen films leads to faulty results if the corresponding partial image strips cannot be printed exactly behind the associated lenses.

In order to meet these requirements, the lenticular screen films are produced in a very complex manner in that, for example, transparent thermoplastic material sheets are provided on one face with a lenticular screen via an embossing process or the lenticular screen film is produced via an extrusion process and subsequently is cut into sheets of specific size. The sheets must thereby be cut likewise with the greatest precision in order to ensure that, for example, at least one cut edge runs exactly parallel to the rows of lenses and, for example, the cut edge of each sheet is the same distance from the lens of the adjacent lenticular screen sheet, so that a precise positioning of the printed image to the lenses of the lenticular screen sheet in a printing machine is rendered possible.

It is easy to see that the production of such lenticular screen sheets is complex and expensive because of the maintenance of the edge conditions cited by way of example alone and a commercial application is therefore possible only in certain zones.

Sheets of this type are sold, for example, by the American company PACUR and are expensive due to the cited production process and are therefore used only in a limited market. Furthermore, such materials are not available in rolls, which makes their use, for example, in the packaging industry even more difficult. If packaging or other articles are nevertheless to be provided only partially with a lenticular printing, in particular due to the high cost, additional steps such as cutting, stamping, laminating, adhering etc. are necessary in order to apply a lenticular image, for example, to a base film, which further increases the total costs for producing a packaging.

### OBJECTS OF THE INVENTION

It is therefore an object of the present invention to provide an improved system for lenticular printing.

Another object is the provision of such an improved system for lenticular printing that overcomes the above-given disadvantages, in particular that produces lenticular screen elements usable, for example, in packaging printing applications, whereby on the one hand products can be upgraded and on the other hand new market outlets can result.

Another object is to provide a method and an apparatus with which it is possible to produce and print optical structures, in particular the structures necessary for a lenticular printing on a substrate cost-effectively and in any size.

A further object of the invention is to use the process both for a discontinuous sheet substrate as well as for continuous substrate in rolls.

### SUMMARY OF THE INVENTION

A method of making a printed product having an optical effect based on light refraction has according to the invention the steps of applying an embossable coating to face of a substrate in an image zone, embossing an optical structure in the embossable coating, curing the embossed coating, and printing an image on the substrate in the image zone.

Thus object is attained according to a method according to the invention in that at least one printed image is printed on a substrate and an embossable coating is applied in the zone of a printed image on the substrate or a printed image already produced, an optical structure adapted to the at least one printed image being embossed in the coating that together with the at least one printed image produces an optical effect, for example, a lenticular effect at least in some zones and the embossed optical structure and/or the at least one printed image being permanently fixed.

The object is further attained through an apparatus in particular a printing machine with several treatment stations through which a substrate can be guided, the treatment stations including at least one printing apparatus by means of which at least one printed image can be printed on the substrate, and at least one coating device by means of which the substrate in the zone of a printed image or a printed image printed on the substrate can be coated with an embossable coating, an embosser being provided downstream of the coating device by means of which an optical structure can be embossed in a coating produced by the coating device, and wherein the treatment stations furthermore comprise curing devices for curing the at least one printed image and/or the embossed coating.

The method according to the invention and apparatus have the advantage that a transparent embossable and curable coating, for example, a varnish, is applied to a substrate, such as for example a plastic material, in particular a conventional and easily commercially available plastic material, such as, for example, a plastic film or a plastic sheet, by means of a coating device, the coating being provided in a subsequent step with an optical structure, for example a lenticular screen structure, in that this optical structure is imparted to the surface of the coating, for example, by means of at least one embossing die or an embossing roll. The optical structure, in particular lenticular structure, thus obtained is fixed in a subsequent step, for example, in that the coating is cured by means of UV light when using a radiation-curable coating material.

According to the invention an optical structure means any structure that causes a light refraction in/on the structure.

The substrate thus provided with an optical structure in one possible embodiment can then be printed with an image directly thereafter on its face lying opposite the structure, so that when the printed image is viewed through the optical structure and through the substrate, the desired optical impression, for example, an alternating image or a 3D representation of an object or a movement scene is produced. The substrate is hereby optically transparent at least in a certain wavelength range, for example, in the visible range of 400 nm to 800 nm.

Alternatively, in a first step an image, for example a lenticular image, is printed on the substrate and in a second step to provide this substrate with the embossable coating from the face opposite the printed image or, however, the produced printed image from the same face and in a subsequent step to provide the coating with an optical structure for example a lenticular embossing adapted to the lenticular image and subsequently to cure it.

In a further alternative embodiment the substrate is optically transparent, for example, only in a range outside the visible spectrum, for example, in the infrared range, which makes it possible to generate a lenticular image invisible with normal viewing, which can be made visible only by means of a corresponding viewing apparatus, and which can hereby serve, for example, as a security feature. It is hereby also possible, for example, to print a substrate only transparent in an infrared range on the front and on the back with different lenticular images and, for example, in a subsequent step to provide only one face of the substrate, for example, the front with an embossable coating and to provide this with a lenticular screen. This results advantageously in a double effect in that the lenticular image printed on the front is visible with normal viewing through the lenticular screen and the image printed on the back of the substrate with a viewing in the infrared range.

According to the invention with the above-described embodiments the coating is applied only in partial zones of a substrate. For example, a printed image can then be produced also only in these partial zones. Likewise the substrate can be provided over its entire surface with a printed image and an optical structure.

It is advantageous with the method according to the invention that sheet-shaped substrates, in particular also as an individual object, as well as roll-type continuous substrates can be coated and printed and the latter subsequently can optionally be wound to form a roll again.

According to the invention the substrate to be coated and to be printed can be transparent or opaque, this statement referring to viewing by the naked eye. It can therefore also be provided that a substrate that is not transparent to the naked eye is transparent in a wavelength range of interest, which can be preferred when a machine detection of a produced printed product is provided.

According to the invention in one embodiment the embossed optical structures form a lenticular structure with cylindrical lenses lying next to one another, all of the lenses being at least essentially identical. Alternatively, the embossed optical structure can also be an array of cylindrical lenses lying next to one another, the lenses having different properties, in particular different widths and/or different radii of curvature. The lenses thus formed can be at least essentially spherical lenses that are present in an ordered or random array.

In another embodiment, which can also be combined with the one previously cited, the optical structure can comprise individual structures that are part of an overall structure for example zones of a lens in particular macroscopically assembled from individual structures, such as, for example, a Fresnel lens.

According to the invention the embossing or optical structure can also represent other optical elements, such as, for example, prisms, wave guides or step indices or also holographic optical elements.

Since the optical structures formed according to the invention in an embossable coating can have a plurality of different shapes, in particular their structural sizes according to the invention lie essentially in the range from 0.1 μm to 500 μm, the term “forming” is used below as a collective term.

There are many demands on a production process according to the invention for a printed product with optical structures, in particular with lenticular screen structures. Thus in particular with a printing of the substrate, such as, for example, a base film from the back, on the one hand the thickness of the substrate and the thickness of the coating, such as for example a coat of varnish and in particular the shape of the embossed structures, such as for example lenses or lens parts must be adapted to one another depending on the respective refractive indices of the materials used such that the focal points of the lenses generated with the optical structures lie exactly on the printed image and thus, resolve, for example on the opposite face of the substrate, in particular exactly on the substrate surface, when the printed image is applied from the opposite face, whereby an optimal effect of an image printed on this face is achieved.

Furthermore, the varnish preferably used for a coating must have a very thixotropic behavior in addition to a good flowability, so that a structure embossed in the surface thereof after removal of the embossing die is retained at least until curing. Varnishes of this type can be produced, for example, in that thixotropy-enhancing agents, for example nanoscale thixotropic agents, such as nanoscale titanium dioxide are added to a conventional varnish. Varnishes with markedly thixotropic properties and a preferably good formability are sold for example by INOMAT under the name INOFLEX.

According to the invention, for example, embossing dies or embossing rolls of metal can be used as embossing die, in the surface of which the relief structures to be embossed have been formed, in particular in that the surface tensions thereof are modified such that it is possible to easily lift the embossing die off the uncured varnish coat, for which a coating reducing the surface tension can be provided on the surface of the structures to be embossed.

According to the invention curing of the coating like the above-described varnish can be carried out in that the coating material, in particular the cited varnish, is already cured at least in part during the embossing process, for example, by means of UV light through the substrate in particular from the opposite side, the embossing die, for example an embossing die or an embossing roll at this time being still in contact with the embossing varnish. This advantageously produces a particularly exact formation of the structure contained in the embossing die in the embossing varnish.

According to the invention, curing of the coating like the above-described varnish can be carried out in that the coating material, in particular the cited varnish, is carried out, for example, in two steps, in that before the embossing process a partial curing in particular a surface curing of the coating is carried out, for example, by means of UV light through which on the one hand the plasticity and thus the embossability of the coating is essentially retained and on the other hand the surface is essentially non-adhesive, which makes it possible to easily remove the embossing die. The complete curing of the embossed coating is carried out subsequently by means of a downstream UV curing device.

According to the invention, for example, embossing dies or embossing rolls of plastic or silicone can be used as embossing dies, in the surface of which the corresponding structures are inserted, for example, by means of a forming process or by means of a lithographic process or through a mechanical processing, in particular wherein the surface tensions thereof are also modified here such that it is possible to easily lift the embossing die off the uncured varnish layer.

According to the invention a coating like the cited varnish can be applied to a substrate only in parts, which furthermore makes it possible to produce a relief on a substrate only in some zones, for example, for the production of certain packaging.

It can then be provided in an embodiment according to the invention of the method that the formed zones of the substrate thus produced directly thereafter are further processed in at least one downstream printing unit, for example, printed with the images. In this case, the apparatus for applying the formed zones can be part of an entire production machine and be embodied as required in a selectable or disconnectable manner.

The application of the embossable coating can be carried out, for example, by means of a printing method such as, for example, by means of a screen printing method, flexographic printing method, an immersion process, etc., or also by means of an inkjet-printing method, wherein it is also possible particularly by means of the latter method to apply embossable zones in variable shape, in particular individually freely programmable shapes of for example letters, numbers, images or logos on a substrate. Thus with each application of the embossable coating different shapes or contours of the embossable coating can be produced. A free programmability thereby means with the coating as well as with the printing, that the shape of the coating/printing can be reset between two successive coatings/printings by a controller, for example a computer.

In one possible embodiment only the zones of the substrate covered with an embossable varnish are embossed by means of an embossing roll designed for a full-zone embossing. In this manner it is possible to provide, for example, serial numbers or other information additionally with an optical effect.

### BRIEF DESCRIPTION OF THE DRAWING

The above and other objects, features, and advantages will become more readily apparent from the following description, reference being made to the accompanying drawing in which:

FIG. 1 shows a first arrangement according to the invention for producing reliefs on a substrate;

FIG. 2 shows a further arrangement according to the invention for producing variable reliefs on a substrate;

FIG. 3 shows a further arrangement according to the invention for generating variable reliefs with variable printing on a substrate;

FIG. 4 shows a further arrangement according to the invention for producing reliefs on a printed substrate.

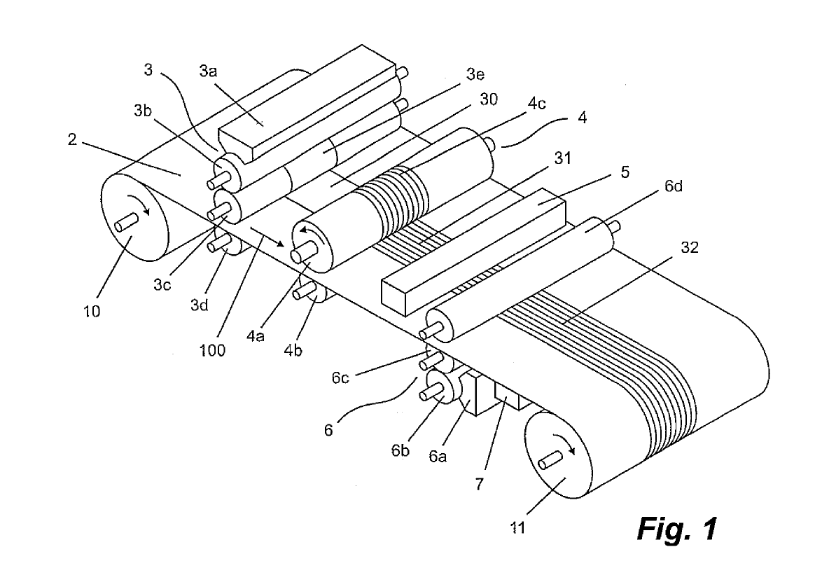

FIG. 1 shows a first embodiment according to the invention for producing forms with printing to produce optical effects that are based on light refraction.

### SPECIFIC DESCRIPTION

A substrate 2 is unwound from a storage roll 10 by means of a drive (not shown) along a transport direction 100 and reaches a first coating device 3 in which, for example, the upper face of the substrate is provided with an embossable coating 30. To this end the coating device 3 has, for example, a reservoir 3a holding the coating material and from which it is removed, for example, by means of an ink intake roll 3b and for example is transferred therefrom by means of an applicator roll 3c to the surface of the substrate 2.

The applicator roll 3c can hereby act as a full-surface application roll or, however, provide only a partial zone of the surface of the substrate 2 with a coating via a corresponding plate 3e, whereby depending on the embodiment of the plate 3e the partial zone can also be formed with an image. For the effective transfer of the coating material onto the surface of the substrate 2, a backing roll 3d can be provided on the lower face of the substrate, on which the substrate 2 and the inking roll 3c are supported.

An embosser 4 arranged downstream presses the desired optical structures, for example, a lenticular screen structure into the surface of the coating 30, so the desired embossing and the desired optical effect result, depending on the resulting thickness of the coating and the corresponding embossed form. To this end, the embosser 4 has, for example, an embossing roll 4a whose outer surface has the desired embossing form 4c and which is imparted to the upper face of the substrate. The embossing roll 4a is thereby supported on another backing roll 4b bearing on the lower face so the coated substrate 2 runs between the backing roll 4b and the embossing roll 4a.

By means of pressure that can be selected in a known manner and a selectable spacing of the embossing roll 4a with respect to the substrate, it is thereby possible according to the invention to adjust the thickness of the embossed layer within certain limits and thus to adapt it to a preset desired thickness.

It is thereby irrelevant according to the invention whether the embosser has a rotationally symmetrical embossing die and works in a continuous process or has, for example, a flat embossing die and works for example in a cycling manner.

To produce a desired optical effect according to the invention, for example, the coating material can be optically transparent at least in a desired wavelength range. Furthermore, it can be advantageous to select the substrate 2 to likewise be transparent in the desired wavelength range, which makes it possible to make the substrate with the embossed coating as a combined optical element. A coating or substrate formed of a transparent material in the desired wavelength range can optionally be opaque to the naked eye.

In order to prevent the coating or at least parts thereof from adhering to the embossing die during the embossing operation, according to the invention the surface tension of the surface of the embossing die or the embossing roll is made as low as possible, in that, for example, the surface is provided with a coating that reduces surface tension or the embossing die is produced from a material with low surface tension such as, for example, a forming silicone mixture such as is sold, for example, by Wacker Chemie.

A curing device 5 downstream of the embosser 4 fixes the coating so that the embossed structures are permanently retained in the surface of the coating.

Since the coating material according to the invention has a high thixotropy, it can be expedient to provide, for example, stirring devices and/or vibrating or shaking devices (not shown) in the reservoir 3a and/or to heat this and/or the downstream of rolls 3b, 3c so that the thixotropy of the coating material is influenced and improved application of the coating material on the surface of the substrate 2 results.

Furthermore according to the invention the coating material 30 applied to the substrate 2 is cooled after the coating step, advantageously resulting in improved embossability.

Furthermore according to the invention the coating material 30 applied to the substrate 2 is at least partially cured after the coating by means of a suitable drying apparatus, for example, by means of a UV emitter such that on the one hand the embossability of the coating 30 is essentially retained and on the other hand the surface of the coating is essentially non-adhesive.

Subsequently in a subsequent step, in particular when using a transparent substrate, for example, by means of a printing apparatus 6 that is assigned to the lower face of the substrate, a printed image adapted to the embossing structure is printed with register accuracy on the face of the substrate 2 facing away from the embossing structure, whereby, for example, when the printed image is viewed through the embossed structure, three-dimensional images or alternating image effects can be achieved.

The printing can be carried out, for example, by means of a known printing process, such as offset printing, flexographic printing or gravure printing, in that, for example, a printed image is transferred to the substrate 2 from an ink chamber 6a via a pickup roll 6b and a pressure roll 6c, the printing unit being braced against a backing roll 6d that in this case bears against the upper face of the substrate.

A subsequent fixing apparatus 7 cures the printed image imprinted permanently.

FIG. 1 hereby shows diagrammatically merely by way of example a single printing unit, wherein of course several different printing units and different printing methods can also be used, depending on the application.

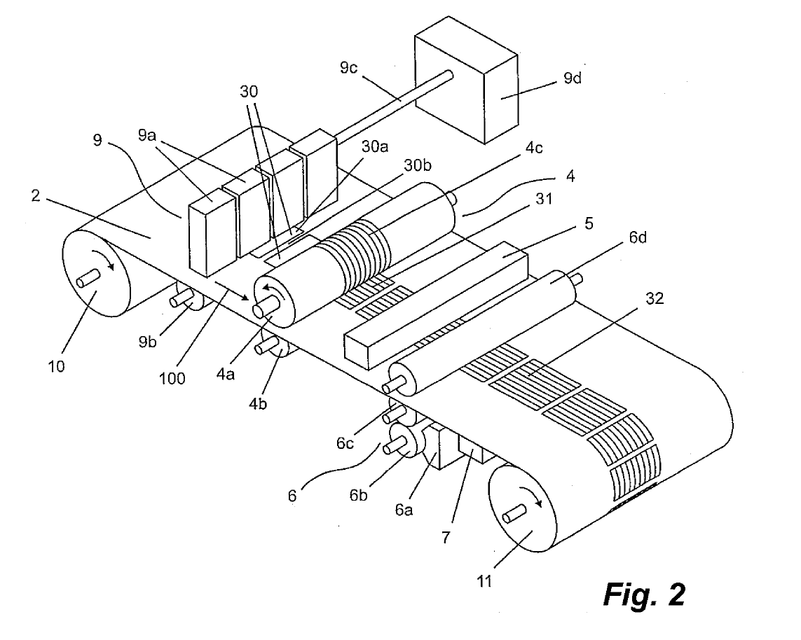

FIG. 2 shows another embodiment according to the invention for producing reliefs on a substrate, the coating material 30 being applied, for example, by means of an inkjet printing method. To this end the applicator 9 has at least one inkjet print head 9a is connected via supply lines 9c to a controller 9d. This way it is possible in a particularly simple manner to provide only certain, in particular freely programmable zones 30a of the printing material 2 with a coating material 30 and to leave free other zones 30b in that the print heads are controlled accordingly via the control and supply unit 9d.

The coated zones are subsequently provided with a shape by means of the downstream embosser 4 acting on the coating, and hereby form shaped zones 31 on freely selectable positions of the substrate that, after fixing by means of a curing device 5, can be printed by means of a printing apparatus 6 as described for example from the back of the substrate. After the printing inks is cured by means of a suitable curing device 7, shapes are thus produced on the substrate 2 with respective imprints, the size and position of the shape being variable.

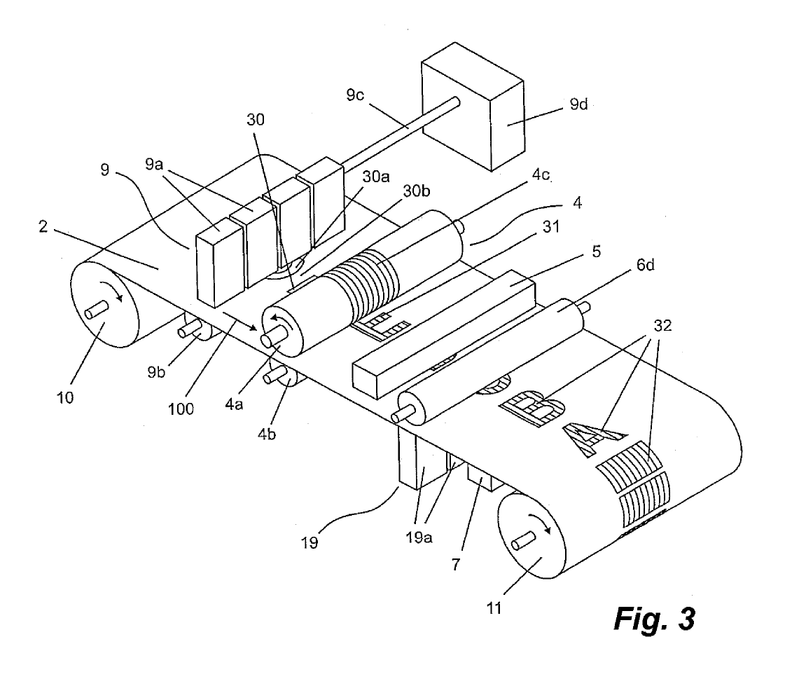

Another embodiment according to the invention is shown by FIG. 3 where the coating of the substrate 2 with a material 30, as in FIG. 2, is carried out by means of inkjet print heads 9a and furthermore the size and shape of the coating can be pictorial in that the coating in the form of text and/or numbers and/or images and/or machine readable codes etc. is applied by means of the ink jet print heads 9a. It is hereby likewise possible, for example, to apply a consecutive numbering, whereby after running through the process steps already mentioned, for example, a consecutive numbering acting in an optically three-dimensional manner can be produced.

Of course, similarly freely programmable print units 19 such as, for example, inkjet print units 19a or laser printing devices or the like can be used instead of the print unit 6 shown diagrammatically in FIG. 3. It is hereby advantageously possible according to the invention to link the coatings 30 applied in a variable manner by means of the coating device 9 to a printed image to be applied, which makes it possible to provide each relief 31 variably with custom imprint.

It is hereby also possible to insert additional features in addition to a general optical effect into each relief element 32 thus produced, so these relief elements can also serve as security elements for product security.

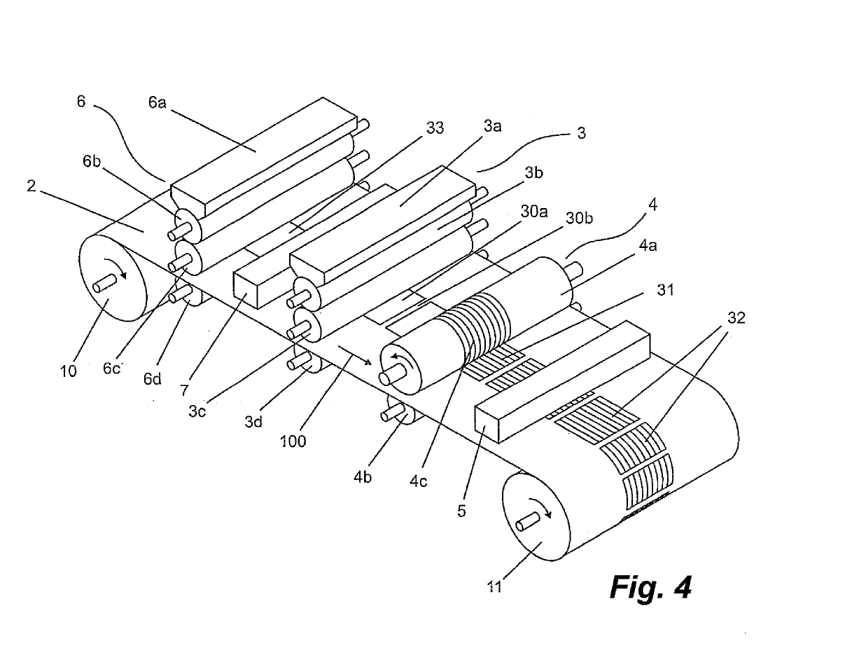

FIG. 4 shows another embodiment according to the invention for producing reliefs. The substrate 2 can thereby be transported, for example, from a storage roll 10 by means of a drive (not shown) onto a takeup roll 11 along a transport direction 100 and thereby, in addition to the treatment stations described below, run through further treatment stations (not shown), such as, for example, surface pretreatment stations, rotating devices, cutting devices or further printing devices.

In a first step the substrate 2 is provided in a first treatment station 6 with an imprint 33 and cured by means of a subsequent fixing apparatus 7.

The imprint 33 can have graphic elements that are adapted to the reliefs that are applied to the imprint in the subsequent processing stations 3 and 4, and a specific optical effect can thus be produced due to an adapted combination of the printing 33 and the relief 31.

In this embodiment the printing devices and the coating devices for the embossable coating thus act from the same face on the substrate.

To this end in a subsequent processing station 3, as already described, the printed zones are coated at least in part with a coating material, which has the necessary forming properties. The coating itself can be carried out, as represented diagrammatically in FIG. 4, by means of a roll coating method, the coating material being taken from a reservoir 3a, for example, by means of a pickup roll in a defined quantity and is applied via corresponding application rolls and/or plate rolls onto the substrate and or onto the printed zones of the substrate.

A downstream embosser 4 in a subsequent step imparts the structures of the roll-shaped embossing die 4c into the surface of the coatings 30a, the desired optical effect being achieved with the imprint lying beneath the relief. A subsequent curing device 5 subsequently fixes the relief permanently.

Naturally, instead of the roll application methods of the printing apparatus 6 and/or the processing station 3 shown diagrammatically in FIG. 4, a variable application process in particular that can be reprogrammed from application to application, for example an inkjet application method, can also be used, whereby as described the production of variable reliefs and variable optical effects are possible.

With respect to all of the embodiments it should be established that the features cited in connection with one embodiment can be used or are used not only with the specific embodiment but also with the other embodiments. All of the disclosed technical features of this description of the invention are to be considered as essential to the invention and can be combined in any manner with one another or used individually. Throughout the entire disclosure when it is mentioned that a feature can be provided or a process step can be carried out, this thereby also means an embodiment of the invention in which the respective feature is provided or a respective process step is carried out.

I claim:

1. A method of making a printed product having an optical effect based on light refraction, the method comprising the steps of:
applying an embossable coating to at least one face of a substrate in an image zone;
embossing an optical structure in the embossable coating;
curing the embossed coating; and
printing an image on the substrate in the image zone.

2. The method defined in claim 1 wherein the embossable coating is applied after the image is printed on the zone.

3. The method defined in claim 2 wherein the image is printed on the face of the substrate and the embossable coating is applied over the image.

4. The method defined in claim 2 wherein the image is printed on a face of the substrate opposite the face to which the embossable coating is applied.

5. The method defined in claim 1 wherein the image is printed on the face to which the embossable coating is applied and also to an opposite face of the substrate in the image zone.

6. The method defined in claim 1 wherein the optical structure is formed as an array of spherical lenses.

7. The method defined in claim 1 wherein the optical structure is formed as an array of cylinder lenses or of prisms.

8. The method defined in claim 1 wherein the embossed optical structures are offset from each other by a spacing.

9. The method defined in claim 1 wherein the embossed structure is a combination of lens elements and prism elements.

10. The method defined in claim 1 wherein the image is printed on the substrate by a printer having a printing plate.

11. The method defined in claim 1 wherein the image is printed on the substrate by a freely programmable printing method.

12. The method defined in claim 1 wherein the coating is applied to the substrate by a printer having a printing plate.

13. The method defined in claim 1 wherein the coating is applied to the substrate by a freely programmable printing method.

14. The method defined in claim 1 wherein the coating is embossed while the coating is only partially hardened.

15. An apparatus for making a printed product having an optical effect based on light refraction, the apparatus comprising the steps of:
conveying a substrate through a coating station, an embossing station downstream of the coating station, a printing station, and a curing station downstream of the coating, embossing, and printing stations;
means in the coating station for applying an embossable coating to face of a substrate in an image zone;
means in the embossing station for embossing an optical structure in the embossable coating;
means in the curing station for curing the embossed coating; and
means in the printing station for printing an image on the substrate in the image zone.

16. The apparatus defined in claim 15 wherein the printing means and the coating means are on opposite faces of the substrate.

17. The apparatus defined in claim 15 wherein the printing means and the coating means are on the same face of the substrate.

18. The apparatus defined in claim 15 wherein the printing means has a printing plate for transferring the image to the substrate.

19. The apparatus defined in claim 15 wherein the printing means is a freely programmable printer that can print separate images.

20. The apparatus defined in claim 15 wherein the coating means has a printing plate for applying the coating to the substrate.

21. The apparatus defined in claim 15 wherein the coating means is freely programmable.

22. The apparatus defined in claim 15 wherein the coating means has a supply chamber holding a mass of embossable thixotropic coating material and is provided with a mixer for maintaining the thixotropic coating material fluid by continuous movement.

23. The apparatus defined in claim 15 wherein the curing means includes a hardening device directed at a face of the substrate opposite the embossing means.

24. A printed product made according to the method comprised of the steps of:
applying an embossable coating to face of a substrate in an image zone;
embossing an optical structure in the embossable coating;
curing the embossed coating; and
printing an image on the substrate in the image zone.

25. The printed product defined in claim 24 wherein the substrate has in the image zone two different images that have the respective optical effects with the embossed coating material from only one side of the substrate.

26. The printed product defined in claim 24 wherein the substrate is not transparent to visible light but is transparent to infrared.

27. The printed product defined in claim 24 wherein the coating is transparent in the visible and infrared spectrum.
